(19) United States
(12) Patent Application Publication
(10) Pub. No.: US 2010/0287552 A1
(43) Pub. Date: Nov. 11, 2010

(54) METHOD FOR PROVIDING INTEGRATED APPLICATION MANAGEMENT

(75) Inventors: Won Young Kim, Daejeon (KR); Sung Joo Kang, Daejeon (KR); Moon Young Chung, Daejeon (KR); Kyoung I Ku, Seoul (KR); Wan Choi, Daejeon (KR)

Correspondence Address: AMPACC Law Group, 3500 188th Street S.W., Suite 103, Lynnwood, WA, 98037, US

(73) Assignee: ELECTRONICS AND TELECOMMUNICATIONS RESEARCH INSTIT, DAEJEON (KR)

(21) Appl. No.: 12/808,102

(22) PCT Filed: Dec. 5, 2008
(86) PCT No.: PCT/KR08/07224

§ 371 Date: Jun. 14, 2010

(30) Foreign Application Priority Data
Dec. 17, 2007 (KR) 10-2007-0132590
Jul. 4, 2008 (KR) 10-2008-0064945

(51) Int. Cl. G06F 9/46

(52) U.S. Cl. 718/100

(57) ABSTRACT

The present invention relates to a method for providing integrated application management, and more particularly, to a method which can provide a convenient usage environment by integrately managing various types of contents and application programs. To achieve these, the method for providing integrated application management using an integrated application service module and a plurality of execution/management engines includes: integratedly managing a plurality of applications driven in different application deployments, and providing a single user interface irrespective of the application deployments; and executing at least one of the applications. The present invention enables various types of application driven in different application deployment to be integratedly executed and managed by a single common interface in a same manner irrespective of each application deployment.

### TECHNICAL FIELD

The present invention relates to a system and a method for providing integrated application management, and in particular, to a method for providing integrated application management, which can provide convenient usage environment by integratedly managing various types of contents and application programs.

This work was supported by the IT R&D program of MIC/IITA. [2007-S-015-01, Development of a Personalized SW Service Platform on Movable Disk Devices]

### BACKGROUND ART

The types of application deployment to users of personal computers have been diversified due to the development of network. That is, various types of application deployment, such as a general packaged application which is installed and used in a computer, a streaming-based packaged application capable of being directly used without downloading and installing, server-based computing (hereinafter, referred to as SBC) application, web-based applications which interact with DBMS and a web server have been provided to users.

However, users have to access the application according to each application deployment.

For instance, to execute the application installed in his local computer, a user must click the icon of the application or the icon of a file created by the application. To execute web-based application, the browser-based application should be executed after connecting to the related servers such as a web server and a database server. For the SBC application, a designated application s icon may be also selected and executed in connection with a SBC server.

For the reason of above described, users should have knowledge about each application deployment, and cannot uniformly access the contents in his computer. Accordingly, the complexities and difficulties have been increasing in use and managing the application and the contents.

### DISCLOSURE OF INVENTION

### Technical Problem

An object of the present invention is to provide a method for providing integrated application management, which enable to provide a convenient usage environment by integratedly managing various types of contents and application with a single user interface.

### Technical Solution

To achieve these and other advantages in accordance with the purpose(s), in one aspect of the present invention, a method for providing integrated application management using an integrated application service module and a plurality of execution/management engines includes: integratedly managing a plurality of applications driven in different application deployments, and providing a single user interface irrespective of the application deployments; and executing at least one of the applications.

In another aspect of the present invention, a method for providing integrated application management includes: receiving information of applications capable of being executed in a computer with each deployment receiving the execution command of a specific application with a single user interface; confirming an availability of the specific application; determining any one of the specific application and an alternative application as an execution application in accordance with a result of the confirmation; and selecting a corresponding execution engine pertinent to the determined execution application, and executing the application using the selected execution engine.

### ADVANTAGEOUS EFFECTS

The present invention provides a united usage environment to users by executing and managing various types of application and contents on the basis of an integrated application platform with a single user interface.

The present invention enables a user to easily add an execution engine and a relevant linkage module to an integrated application platform for a new application service or allows a user to delete those which have been previously added and registered, thereby reducing time and effort for managing an application.

### BRIEF DESCRIPTION OF THE DRAWINGS

These and other advantages of the present invention will become apparent to those skilled in the art upon a reading of the following specification of the invention and a study of the several figures of the accompanying drawings:

FIG. 1 is a block diagram illustrating a configuration of a system for managing an application according to an embodiment of the present invention.

FIG. 2 is a concept diagram illustrating a procedure of adding a new application service to an integrated application platform.

FIG. 3 is a flowchart illustrating a procedure of adding a new application service to an integrated application platform according to the present invention.

FIG. 4 is a structure diagram illustrating the structure of a relation of application, contents and execution engines maintained and managed by an integrated application platform according to the present invention.

FIG. 5 is a flowchart illustrating a method of managing an application according to the present invention.

### BEST MODE FOR CARRYING OUT THE INVENTION

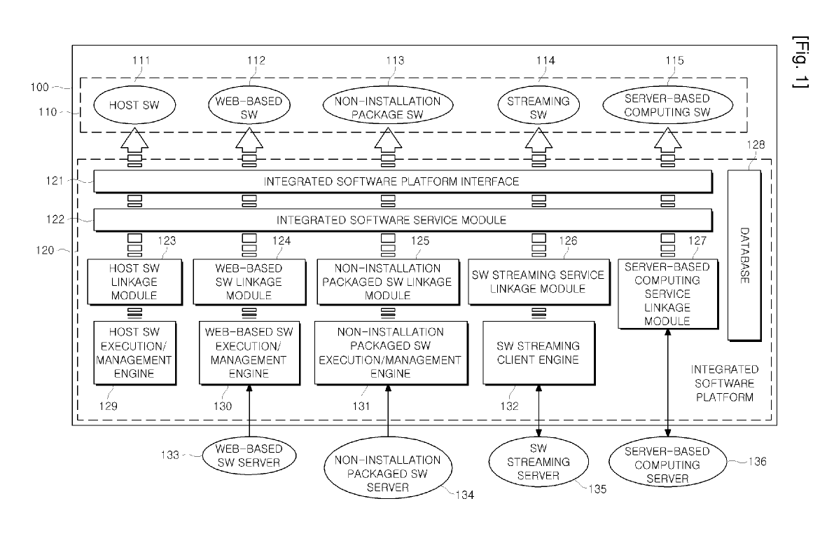

FIG. 1 is a block diagram illustrating a configuration of a system for managing an application according to the present invention.

As shown in FIG. 1, a system for managing applications integratedly according to the present invention includes a computer 100, and an integrated application platform 120 associated with the computer 100.

The computer 100 may execute various types of application 110, such as host application 111, web-based application 112, a non-installation packaged application 113, a streaming application 114, a server-based computing (SBC) application 115. Further, the computer 100 stores various types of contents created, edited, or reproduced by the applications 111 to 115.

The computer 100 may be a personal computer, but is not limited to this embodiment. It is apparent to those skilled in the art that the computer 100 can be any types of computing device such as PDA, PMP, notebook computer, server or workstation, etc.

The integrated application platform 120 is associated with the computer 100 so that it integratedly manages the application 110 and allows a user to execute the application or contents in same manner irrespective of each application deployment.

The integrated application platform 120 may be implemented in such a form that it is installed in the computer 100, as illustrated in FIG. 1. In another embodiment, the integrated application platform 120 can be stored in a separate mobile storage or a server and perform integrated management being connected with the computer 100 via a wire/wireless interface.

The integrated application platform 120 includes an integrated application platform interface (hereinafter, referred to as a user interface) 121 which receives the inputs from a user, an integrated application service module 122, a plurality of linkage modules 123 to 127, a plurality of application execution/management engines 129 to 132, and a database 128.

The user interface 121 provides an integrated execution environment to a user of the computer 100, and allows a user to execute applications, which are driven in different application deployment, in a single manner with a single interface.

The integrated application service module 122 maintains the list of available applications, information about application deployment and driving mechanism with the database 128, and controls the overall operation of the integrated application platform 120.

The linkage modules 123 to 127 collect the application information from the respectively interlinked application execution engines 129 to 132 and transfer the collected information to the integrated application service module 122. And, the linkage modules 123 to 127 transfer an application execution request to each of the interlinked application execution engines 129 to 132.

The linkage module 123 to 127 link the application execution engine(s) with the integrated application platform 120 even in case of the application execution engine having been previously developed with no consideration of with the application platform 120.

The application execution/management engines 129 to 132 invoke a corresponding application and gather information regarding executable application for each application deployment and send the information to the corresponding linkage module. For example, the host application execution/management engine 129 gathers information about all of available applications in the computer 100 and sends it to the host application linkage module 123.

As described above, each linkage module 123 to 127 forwards the information to the integrated application service module 122. And the integrated application service module 122 stores and manages the information of each application availed in the computer 100, and relation information between linkage module, execution engine and application in the form of an application availability list. Moreover, it manages the contents (i.e. data file) access information including which an application can create, alter, play, edit, read or delete certain contents and the alternative application information.

That is, the integrated application service module 122 maintains information of the lists and providing schemes of all current usable applications with their availability.

An availability of an application may be changed in accordance with the network state. When the computer 100 is not connected with the network, the streaming application 114 and the SBC application 115 interworked with the remote servers are not availed. However, if the application is downloaded from the server and installed in the computer 100 previously, it may be continuously operable irrespective of network state.

Thus the integrated application service module 122 updates and maintains an application availability list in consideration of above described.

The computer 100 associated with the integrated application management platform 120 executes the each application as following ways.

When a user requests the execution of the host application 111 with the user interface 121, the integrated application service module 122 transmit the execution request to the host application linkage module 123 based on the application availability list. The host application linkage module 123 let the host application execution/management engine 129 invoke the host application 111.

When a user wants the service of the web-based application 112, the web-based application linkage module 124 immediately requests the execution of a corresponding application to the web-based application execution/management engine 130 in case of the requested web-based application has been already installed in the computer 100

If the requested application is not installed yet, the web-based application linkage module 124 requests the installation and execution of web-based application to the web-based application execution/management engine 130. Then, the web-based application execution/management engine 130 downloads an necessary application, and thereafter invokes the web-based application 112.

A user may also request the execution of the non-installation package application 113. In that case, if the non-installation packaged application 113 has been already downloaded, the non-installation packaged application linkage module 125 immediately executes the downloaded one through the non-installation packaged application execution/management engine 131. However, if the non-installation packaged application 113 is not yet downloaded, the non-installation packaged application linkage module 125 downloads the non-installation packaged application 113 from the non-installation packaged application server 134 and then enables to use the non-installation packaged application 113 through the non-installation package application execution/management engine 131.

In a case of the streaming application 114, if the application streaming client engine 132 is not yet started, the application streaming service linkage module 126 drives the application streaming client engine 132 to thereby provide a service by the streaming application 114.

In a case of the SBC application 115, the SBC service linkage module 127 accesses to the SBC server 136 and provides an availed application list to a user, and enables the user to immediately execute the requested application in connection with the SBC server 136.

Since the integrated application platform 120 performs the above-described procedures, it can provide a user with an integrated usage environment which may execute various types of application deployment with a single user interface in same manner.

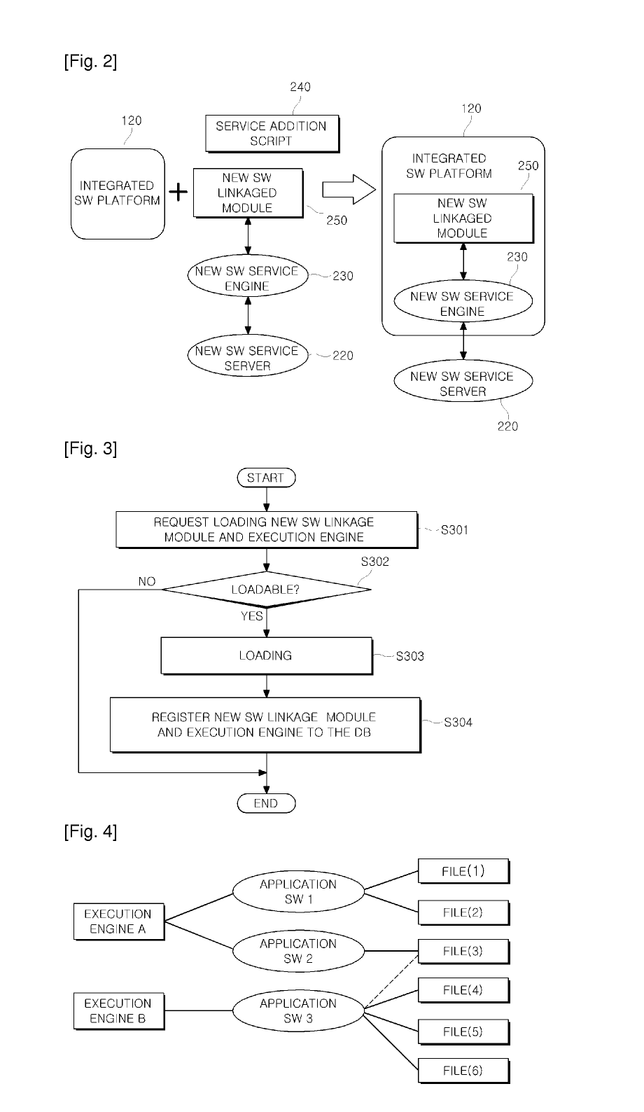

FIG. 2 is an indication diagram illustrating a procedure of adding a new application service to an integrated application platform. Referring to FIG. 2, in order to add a new application service, a new application linkage module 250 suitable to the application deployment of a new application should be developed and registered to the integrated application platform 120 together with a new application service engine 230.

It is preferable that the addition/register procedure is performed by use of a service addition script 240 in view of efficiency.

The new application service engine 230 and/or new application linkage module 250 may be received from a new application service server 220.

The above-mentioned addition/register procedure will be described in detail with reference to FIG. 3 which is a flowchart illustrating a procedure of adding and registering a new application service to an integrated application platform.

As seen in FIG. 3, when a user requests adding a new application interworking module and an execution engine in step 301, the integrated application platform 120 determines whether the load of the new application linkage module and execution engine is possible in step S302.

If so, the integrated application platform 120 loads the new application linkage module and execution engine in step 303.

Subsequently, the integrated application platform 120 registers and manages the new application linkage module and execution engine in the database 128 using the service addition script 240 in step S304.

FIG. 4 is a diagram illustrating the relation and management structure regarding contents and application of the integrated application platform according to the present invention.

Referring to FIG. 4, it is indicated that applications 1 and 2 are executed by an execution engine A, files (1) and (2) can be accessed by the application 1, and file (3) can be accessed by the application 2.

An application 3 is operated by an execution engine B, and files (4) to (6) may be accessed by the application 3.

FIG. 4 illustrates the relationship between execution engines, plural application and contents in view of not only creating relationship but also various types of accessing relationship including edition, play, alteration, regeneration or deletion.

Accordingly, the integrated application management system according to the present invention constructs and maintains relationship information as shown in FIG. 4. Therefore, when the access request to certain contents (files) is generated or a execution request for any one of the applications 111 to 115 is input, the integrated application platform grasps and specifies a appropriate corresponding linkage module and execution engine on the basis of the relationship information, thereby providing the integrated usage environment for applications and the contents to users.

For example, when a user intends to access the file 3, the integrated application platform 120 according to the present invention basically allow the execution engine A to call the application 2 and access to the file (3) depending on the relationship information shown in FIG. 4. However, when the execution engine A or the application 2 is in failure or malfunction states, the integrated application platform 120 perform an alternative execution that allows the execution engine B to access to the file (3) through the application 3. The dotted line in FIG. 4 indicates the alternative relationship between the application 3 and file (3).

Since such a relationship information is recorded in the database 128, when a certain contents is accessed or there is a driving request of a specific application, the integrated application platform 120 call a linkage module corresponding to a pertinent application service and execution/management engines corresponding to the linkage module on the basis of the relationship information.

Likewise, when application requested by a user is not availed, the integrated application platform 120 search an alternative application capable of performing the same or similar functions and suggest the alternative application to the user or execute it directly.

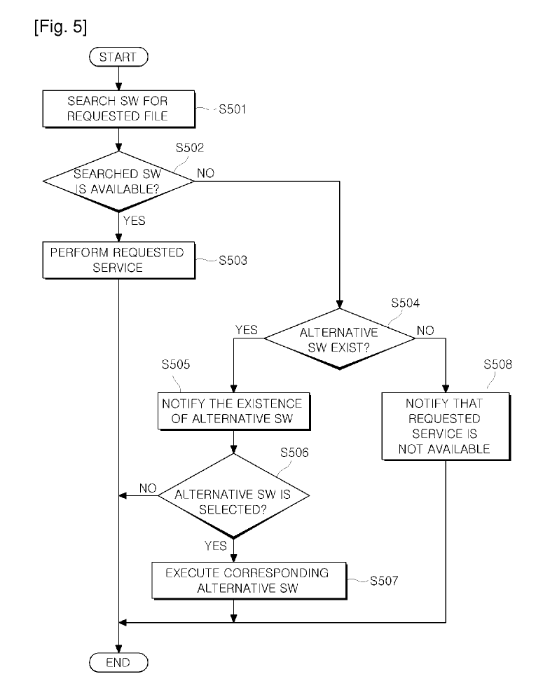

FIG. 5 is a flowchart illustrating a method for managing applications integratedly according to the present invention including a suggestion or execution of an alternative application.

As seen in FIG. 5, when a user requests the execution of specific contents or file, the integrated application management system according to the present invention search a most suitable application in step S501.

Subsequently, determine the availability of the searched application in step S502.

When the searched application is available, it is executed in step S503.

However, when the searched application is not available, whether an alternative application exists or not is checked in step S504.

When the alternative application exists, it may be notified to a user in operation S505, by exhibiting a notification message or generating a notification sound or by any other appropriate notification way.

Then, if a user selects alternative application in step 506, the integrated application management system executes the alternative application to provide a corresponding service in step S507.

In another embodiment, it may be configured to provide a service with the searched alternative application without notification or user's selection, when an alternative application service is searched.

When the alternative application does not exist, the system notifies that a corresponding application is not available to a user in operation 5510, by exhibiting a notification message or generating a notification sound or by any other appropriate notification way.

The foregoing description of the embodiments of the present invention has been presented only for the purpose of illustration and description and not intended to be exhaustive or to limit the invention to the precise forms disclosed.

Numerous modifications and adaptations thereof will be apparent to those skilled in the art without departing from the spirit and scope of the present invention.

1. A method for providing integrated application management using an integrated application service module and a plurality of execution/management engines, the method comprising:
integratedly managing a plurality of applications driven in different application deployments
providing a single user interface irrespective of the application deployments; and
executing at least one of the applications.

2. The method of claim 1, wherein the managing of the applications comprises:
managing, by the an integrated application service module, a list of the application available in a computer, and controlling overall operations for the available application execution;
collecting, by the execution/management engines, information of the applications, and executing the applications and interworking the integrated application service module with the execution/management engines.

3. The method of claim 2, wherein in the collecting of the information and the executing of the applications, the respective execution/management engines drive the applications in the different application deployments.

4. The method of claim 2, wherein the executing of the applications comprises at least one of:
driving an application based on a host;
driving an application based on the Web;
driving an application in a streaming manner;
driving an application based on a server; and
driving a non-installation package application.

5. The method of claim 1, further comprising storing relationship information between at least one application driven by the execution/management engines and contents accessible by the applications.

6. The method of claim 1, further comprising adding a corresponding linkage module and a corresponding execution engine, which service an application driven in a new application deployment, using service addition script.

7. The method of claim 1, further comprising storing information of each application and its alternative application.

8. The method of claim 7, further comprising executing an alternative application capable of executing specific contents on the basis of the stored information when a requested application is not available upon request of contents execution.

9. A method for providing intergrated application management for a plurality of applications driven in different application deployments, the method comprising:
receiving information of the applications capable of being executed in a computer;
receiving the execution command of a specific application through a single user interface;
confirming an availability of the specific application;
determining the execution application from the specific application and its alternative application in accordance with a result of the confirmation
selecting a corresponding execution engine pertinent to the determined execution application and
executing the determined application via the use of the selected execution engine.

10. The method of claim 9, wherein the determining of the execution application comprises:
determining the specific application as the execution application, when the specific application is availed; and
selecting the alternative application as the execution application, when the specific application is not available.

11. The method of claim 10, wherein the selecting of the alternative application includes:
providing the alternative application to a user through user interface and receiving user's selection command.
